(19) United States
(12) Patent Application Publication
(10) Pub. No.: US 2022/0004939 A1
(43) Pub. Date: Jan. 6, 2022

(54) RESERVATION SYSTEM

(71) Applicant: George VonAllmen, Cincinnati, OH (US)

(72) Inventor: George VonAllmen, Cincinnati, OH (US)

(21) Appl. No.: 17/475,624

(22) Filed: Sep. 15, 2021

Related U.S. Application Data
(63) Continuation of application No. 16/700,320, filed on Dec. 2, 2019.
Application No. 16/700,320 is a continuation of application No. 15/954,820, filed on Apr. 17, 2018, now abandoned.
Application No. 15/954,820 is a continuation-in-part of application No. 14/567,098, filed on Dec. 11, 2014, now abandoned.
Application No. 14/567,098 is a continuation-in-part of application No. 13/180,641, filed on Jul. 12, 2011, now abandoned.

(51) Int. Cl. G06Q 10/02

(52) U.S. Cl. CPC G06Q 10/02; G06Q 50/01

(57) ABSTRACT

The reservation system hereof operates to provide a collaborative network whereby users provides user information including preferences to a administrative module that operates to create a user's preference profile for each user having a reservation for an accommodation at a location for a specific period of time and places each user in a group based on the user's preference profile and cooperates with the room administrative system at the location to assign accommodations at the location and for the specific period of time based on the group.

### CROSS-REFERENCE TO RELATED APPLICATIONS

This is a Continuation of U.S. patent application Ser. No. 16/700,320, filed Dec. 2, 2019, which is a Continuation of U.S. patent application Ser. No. 15/954,820, filed Apr. 17, 2018, which is a Continuation-In-Part of U.S. patent application Ser. No. 14/567,098, filed Dec. 11, 2014, which is a Continuation-In-Part of U.S. patent application Ser. No. 13/180,641, filed Jul. 12, 2011, which are incorporated herein in their entireties.

### COPYRIGHT NOTIFICATION

Portions of this patent application contain materials that are subject to copyright protection. The copyright owner has no objection to the facsimile reproduction by anyone of the patent document or the patent disclosure, as it appears in the Patent and Trademark Office patent file or records. The copyright owner, however, otherwise reserves all copyright rights whatsoever.

### BACKGROUND OF THE INVENTION

The present invention relates to a reservation system, and more particularly to an interactive reservation system that provides a collaborative system and process in which users (such as an individual) interested in making a reservation are organized by their interests, lifestyle, and preferences (collectively referred to as “Preferences”) and interacts with one or more booking reservation systems that together operate to determine availability at a location that complies with or most closely complies with the Preferences. The system further operates such that users can participate in a personal contact network and such that businesses can communicate with select users or select group of users within the system thereby providing additional and targeted marketing opportunities.

The interconnectivity of individuals, and organizations has increased significantly in recent years with advent of various telecommunication means, including the Internet. The Internet has connected people, businesses, and organizations through various means that include online bulletin boards, email, and online instant messaging. Personal and business decisions are often directly or indirectly affected by the preferences, tastes and actions of one's friends, colleagues and acquaintances. Further, an individual's choice is also influenced by available information provided to them through various sources. Additionally, a recommendation, or an adverse comment from a close trusted acquaintance regarding a specific business will often override other factors in an individual's decision. Accordingly, businesses are actively looking for ways to improve their reputation among customers, such as providing better service or more favorable customer experiences, as well as developing ways to improve or optimize their marketing efforts.

Individuals today are often confronted with a daily surplus of social information that competes for the individual's attention in almost every aspect of their work, recreation, and social lives. A popular form of advertising on large private networks or public networks, such as the Internet, is through the use of electronic mail. In a typical scenario, companies purchase or collate lists of user email addresses and then send unsolicited commercial messages, such as advertisements, announcements, etc., to those users. Commonly known as “spam” or electronic junk mail, these messages often relate to goods or services which the recipient doesn't want or need. The response rate to these types of unsolicited messages is extremely low, typically less than one-tenth of one percent and the vast majority of the messages are deleted without even being read. In addition, because of the volume of unsolicited messages received by a typical party, there is a high likelihood that the recipient will become biased against the sponsor of the message because of the unwelcome method of delivery, even if they might otherwise be interested in the subject matter. Further, advertisements in the form of mailers, fliers, and the like are often simply ignored or the information is discarded before even having reviewed it. In contrast, individuals generally who actively seeking information or have intentionally visited a web site typically will examine the offers and opportunities provided.

Nevertheless, because the Internet can provide individuals directly with advertisements, businesses often utilize the Internet as a medium for advertising. While the Internet is a relatively inexpensive way to directly supply individuals with advertisements and information, advertisers are looking for ways of reaching users more effectively with advertisements for the products and services without the drawbacks discussed above. One approach to the problem of general broad advertising that has been developed is to target messages to particular individuals according to their interests. In a typical situation, an individual will access an Internet web-page which provides a list of various subject categories. The individuals then subscribe to one or more categories that interest them and provide their email address and various types of demographic information. The premise behind this approach is that the listed addresses represent individuals who have taken the affirmative step of voluntarily signing up to receive commercial email about topics of interest, and thus the response rate should be greater than completely unsolicited email. However, this premise is only somewhat correct. In practice, a certain percentage of subscriptions are not made by the listed party, but rather result from the action of third parties. Thus, when a company uses a given subscription list to target commercial messages, many of the recipients will consider the messages to be unsolicited advertisements, resulting in the generation of bad-will toward the company. Even if the recipient is provided with the option of having them removed from the mailing list, this option is not available until after the fact, and so is relatively ineffective in preventing at least some unsolicited messages from being sent. Further, such systems typically rely on an individual specifically going to the web-page of the business. Such web-pages must always be updating their web-pages with current offers and typically do not provide offers in advance.

Methods and systems have also been developed in connecting individuals, such as the system described in U.S. Pat. No. 7,761,386. Such systems typically operate whereby subscribers input information to specify their level of interest in specific attractions. The systems operate to facilitate the connection with specific other subscribers and in arranging their preferred schedules for an outing. Such systems may also operate to identify and match individuals who are interested in the same attraction, who favor each other's company, and who are free at the same time. The system notifies the matched individuals, optionally offering ticketing and/or reservation assistance. Partial matches are optionally referred to the respective subscribers for negotiating the unmatched schedule or attraction. The system, such as in U.S. Pat. No. 7,761,386, is also adaptable to serve singles who wish to identify and get to know prospective mate through mutual visits to attractions, as well as individuals, couples, and families who want to go out with their existing friends or make new friends. However, until now, such systems do not operate whereby one or more individuals can provide information into a system that cooperates with or is incorporated into a room reservation system (such as for a motel, hotel, ship or resort), such that individuals with like Preferences are grouped together or are provided with opportunities to participate in various activities of mutual interest during their time at a location.

Accommodation room reservations systems (such as used for hotels, motels, ships, resorts, time shares, and the like) typically operate to assign one or more individuals into specific rooms that are sized to accommodate the individual(s) needs or requests. According, since such accommodations are based on an individual's needs it is not uncommon for the reservation system to place older individuals in a room next door to or near a room having much younger occupants. This often results in the older individuals having an unpleasant stay due to noise levels often caused by activities of the younger occupants or for younger individuals having to limit their activities to maintain noise levels. Further, such reservation systems often do not allow individuals to request rooms based on the room's location, such as the room's location with respect to a swimming pool, elevator, entrances/exits, floor, and the like. Such requests normally must be done directly with a reservationist at the location and is often done only at check-in or on a daily basis. Thus, accommodation openings often are assigned at the end of the day or at check-in which reduces the ability to accommodate requests. Thus, current reservation systems do not automatically reserve the room for an individual wishing a particular accommodation immediately upon it becoming available. Further, current reservation systems do not operate to group individuals having common Preferences together. While systems may place an individual in an accommodation, they are limited in that they may operate to comply with a single request, such as for example a request for a room by a pool, they do not consider an individual's other Preferences, such as a room by the pool but away from rooms having children. Further, many reservation systems only operate to allow an individual to make a reservation for a room of a certain size or having a specific size of bed thereby requiring an individual to make a more specific request at the time of check-in. Unfortunately, rooms meeting an individual request at the time of check-in are often occupied by that time and often by individuals who would have been satisfied with another accommodation.

Accordingly, what is needed is a system that is part of one or more booking reservation system or cooperates with one or more booking reservation systems and provides a collaborative process in which users making reservations for a space (such as a room) can input information into the system that operates to group users having similar Preferences. Further, a system is needed that allows accommodations that meets a user's needs or Preferences to be assigned to the user immediately upon an accommodation becoming available that better complies with the user's Preferences. A system is also needed that further allows users to make contact with such other users having a reservation at the same location and period or time and which allows businesses to market to such users without the drawbacks of attributed to unsolicited advertisements, thereby optimizing the businesses marketing efforts and effectiveness.

### SUMMARY OF THE INVENTION

The subject invention is a reservation system that incorporates or cooperates with one or more booking reservation systems that operates to allow Users to make a reservation for an Accommodation at a specific Location and for a specific period of time and operates to group such Users with other Users having a reservation for an Accommodation at the same specific Location and period of time. The reservation system operates such that the grouping is based on the specific Preferences of the Users.

In a preferred embodiment of the invention, the reservation system operates to place grouped Users in an Accommodation such that the Accommodations are the closest proximate Accommodations to each other that are available.

In another preferred embodiment of the invention, the reservation system operates to place Users in accommodations that most directly matches a User's primary Preference.

In another preferred embodiment of the invention, the reservation system operates to weigh a User's Preferences and places the User in an Accommodation that most directly matches the User's weighted Preferences.

In another preferred embodiment of the invention, the reservation system continually monitors changes in reservations made for a period of time at a Location and modifies Accommodations for Users to better match the Preferences of the Users.

In another preferred embodiment of the invention, the reservation system monitors changes in reservations made for a period of time at a Location and modifies assigned Accommodations in real time for Users such that Accommodations are closer to Accommodations of other User's within the group.

In another preferred embodiment of the invention, the reservation system continuously monitors changes in reservations made for a period of time at a Location and changes Accommodations to more closely match user's Preferences as Accommodations become available.

In another preferred embodiment of the invention, the reservation system continually monitors changes in reservations made at a Location and modifies reservations for Users to more closely align with the Users' Preferences.

In another preferred embodiment of the invention, the reservation system operates to provide a private personal telecommunication system whereby a User having a reservation at a Location for a specific period of time can be placed in contact with other Users at the Location and for the same period of time and who share the same or similar Preferences.

In another preferred embodiment of the invention, the reservation system operates with a general reservation system to allow Users the ability to review various Locations to determine if other Users having similar Preferences made reservations for a specific time period at a Location.

In another preferred embodiment of the invention, the reservation system provides a User with the ability to receive information from specific Business Entities that have been identified by the reservation system as providing services and/or products that may be of interest to the User.

In another preferred embodiment of the invention, the reservation system provides a User the ability to invite other Users to participate in a social activity.

In another preferred embodiment of the invention, the reservation system provides Users with the ability to acknowledge their intent to participate in a social activity.

In another preferred embodiment of the invention, the reservation system provides Users with the ability to create user preference profiles that may be viewed by other Users having reservations or an interest in making a reservation at the Location for the specific period of time.

In another preferred embodiment of the invention, the reservation system allows a User to search and determine if other Users having the same of similar Preferences have reservations at a Location for a specific period of time.

In another preferred embodiment of the invention, the reservation system has a communications network that communicates with one or more Business Organization communication systems and is effective for receiving and transmitting information to identify Business Organization members having a reservation at a specific Location.

In another preferred embodiment of the invention, the reservation system allows Business Organizations to batch load into the system an entire membership listing and wherein the system operates to communicate with individual members to notify them that other members have made reservations at a location for a specific period of time.

In another preferred embodiment of the invention, the reservation system allows a User to identify specific Business Organizations that the User is interested in receiving information concerning the business, events or offers made by the Business Organization.

In another preferred embodiment of the invention, the reservation system allows a reservation entity to post information concerning a business, event, or offer information on the reservation system.

In another preferred embodiment of the invention, the reservation system allows a business entity or reservation entity to send information to a User identified by the user's preference profile as being interested in such information.

In another preferred embodiment of the invention, the reservation system operates to allow event and offer information to be transmitted to Users via a plurality of modems.

In another preferred embodiment of the invention, the reservation system comprises a computer system having a processor and a computer-readable medium with computer-readable instructions for performing a method of operating the system, wherein the computer is linked to user's communication devices to permit Users to make reservations and input user information into the system that is used to group the Users.

In another preferred embodiment of the invention, the reservation system comprises an interactive communications interface having means for Users having a reservation at a specific Location and period of time to post messages for review by other Users having reservations at the same Location for the same or overlapping period of time.

In another preferred embodiment of the invention, the reservation system comprises an interactive communications interface for allowing instant messaging between Users.

A preferred embodiment of the invention is a reservation system for use by one or more users to make a reservation for an accommodation at a location for a specific period of time, the reservation system comprising an administrative module, a plurality of user communication devices for use by users in making reservations, a communications network connecting each user communication device to the administrative module, wherein the administrative module operates to receive user information from each user through the user communication device and uses the user information to create a user preference profile for each user and uses the user preference profile to place each user into a group and wherein the administrative module communicates with a room administrative system to assign an accommodation at the location for the specific period of time based on the group.

In a preferred embodiment of the invention the reservation system of the user information includes user hobbies, such that each group consists of users having the same or similar hobbies.

in another preferred embodiment the reservation system the administrative module further operates to cooperate with the room administrative system to continuously monitor reservations at the location and the specific period of time and further cooperates with the room administrative system to modify accommodations to more closely comply with each user's preference profile.

In another preferred embodiment the reservation system further comprises business communication devices that operate to receive business information from a business entity and transmit the business information to the administrative module for storage in a business data bank, and wherein the administrative module further operates to transmit the business information to one or more users based on the user's preference profile.

In a preferred embodiment the administrative module further operates to receive business information comprising a listing of members of a business organization, and wherein the administrative module further operates to identify a user making a reservation at the location for the specific period of time as being listed on the listing of members and notifies the user of other users listed on the listing of members who have made a reservation at the location for the same period of time.

In a preferred embodiment the business information comprises events and/or offer information.

In a preferred embodiment the administrative module operates such that users each having a reservation at the same location and for the same or overlapping period of time can communicate with each other using the user communication devices.

In a preferred embodiment the reservation system further comprises one or more displays having display fields and windows for entering and receiving user information.

In a preferred embodiment the reservation system for use by one or more users to make a reservation for an accommodation at a location for a specific period of time comprises an administrative module, a plurality of user communication devices for use by users in inputting and receiving user information, wherein the user information comprises user preferences, one or more business communication devices for use by business entities to input and receive business information, a communications network connecting the user communication devices and the business input/output devices to the administrative module, wherein the administrative module operates to receive user information from each user and uses the user information to create a user's preference profile for each user and to place each user into a group based on the user's preference profile, wherein the administrative module then communicates with a room administrative system that operates to assign an accommodation at the location for the specific period of time, wherein the administrative module and the room administrative system then cooperate to assign an accommodation for each user at the location for the specific period of time based on the group and then operates to transmit business information to users based on said group.

In a preferred embodiment the group is based on weighted preferences in the user's preference profiles.

In a preferred embodiment the administrative module then operates to communicate with the room administrative system to continuously monitor reservations at the location and specific period of time and modify accommodations to more closely comply with each user's preference profile.

In a preferred embodiment the administrative module operates to receive business information comprising a listing of members of a business organization, and wherein the administrative module then operates to communicate with a plurality of room reservation systems to identify a user making a reservation as being listed on the listing of members and notifies the user of other users listed on the listing of members who have made a reservation at a location for a period of time.

In a preferred embodiment of the invention the reservation system for use by one or more users to make a reservation for an accommodation at a location for a specific period of time, the reservation system comprises an administrative module, a plurality of user communication devices for use by users in inputting and receiving user information, wherein the user information comprises user preferences, one or more business communication devices for use by business entities to input and receive business information, a communications network connecting the user communication devices and the business input/output devices to the administrative module, wherein the administrative module operates to receive user information from each user and wherein the user information includes preferences, wherein the preferences includes weighted preferences; the administrative module then operates to create a user's preference profile for each user based on the preferences and uses the user's preference profile for each user to place each user into a group, wherein the administrative module then communicates with a room administrative system to assign an accommodation at the location for the specific period of time based on the group, wherein the administrative module then operates to transmit business information to users based on the group and the administrative module then operates to communicate with the room administrative system to continuously monitor reservations at the location and specific period of time and modify accommodations to more closely comply with each user's preference profile.

These and other benefits, advantages, and embodiments of the invention will be apparent from the following description, the accompanying drawings and the appended claims.

### BRIEF DESCRIPTION OF THE DRAWINGS

Features, aspects, and advantages of the present invention will become better understood with regard to the following description, appended claims, and accompanying drawings where:

FIG. 1 is a schematic representation of the reservation system having one or more user communication devices and one or more business communication devices for transmitting and receiving information from an administrative module and for use in making a reservation for an Accommodation at a Location for a period of time;

FIG. 2 is a schematic representation of a preferred embodiment of the reservation system of the subject invention showing an individual communication device for transmitting user information to the administrative module and a business communication device for transmitting business information to the administrative module and a room administrative system in communication with a booking reservation system that cooperate to transmit reservation information to the administrative module;

FIG. 3 is a schematic representation of a preferred embodiment of the administrative module having memory with a business data bank and a user's data bank for storing information and communicating with a business module and a user's module;

FIG. 4 is a schematic representation of the reservation system showing the administrative module in communication with the Reservation Entity and one or more Users making a reservation through a booking reservation system in communication with the administrative module and a User transmitting user information and Preferences to the administrative module;

FIG. 5 is a schematic representation of the reservation system showing the business module having a business portal for use in communication with one or more Business Organizations;

FIG. 6 is a schematic representation of the reservation system showing the user's module having a user portal and a system server that operates to create an entry point for interacting with the user's communication device for creating displays;

FIG. 7 is an exemplary illustration of a representative opening display for viewing on a user's communication device and having a plurality of displayed fields for use by Users for navigating and using the various features of the reservation system using the user's communication device;

FIG. 8 is an exemplary illustration of a representative reservation display for viewing on a user's communication device and having reservation input fields and windows for making a reservation at a Location for a specified period of time and one or more windows for reviewing user information;

FIG. 9 is an exemplary illustration of a representative location display for viewing on a user's communication device having a location field and window for providing information about a specific location;

FIG. 10 is an exemplary illustration of a representative events display for viewing on a user's communication device having at least one events window for displaying an events drop-down listing of various events and for allowing a user to obtain information about various events;

FIG. 11 is an exemplary illustration of a representative message display for showing on a user's communication device having message fields and windows for reviewing, creating and sending messages to friends having reservations at a location during a period of time;

FIG. 12 is a schematic representation illustrating message displays for showing on user's communication devices being generated and/or received by a user and sending and/or receiving a message from a friend using users' communication devices;

FIG. 13 is an exemplary illustration of an offer display for showing on a user's communication device having at least one offer window for reviewing offers from Business Entities and/or a Reservation Entity that may be of interest to a User;

FIG. 14 is an exemplary illustration of a representative preference display having at least one input preference field and window for responding to questions and rating Preferences for use by the reservation system in creating a user preference profile for use in grouping users;

FIG. 15 is a schematic representation illustrating the general methodology and interactive method of a Business Entity for receiving or transmitting business information and a business display for showing on a business communication device having a business opening display and log-in window and a business display having one or more business fields for editing and reviewing user preference profile information;

FIG. 16 is a flow chart illustrating the general methodology and interactive method for informing Users of other Users (friends) that have the same or similar Preferences;

FIG. 17 is a flow chart illustrating the general methodology and interactive method of the reservation system showing Users having similar Preferences being grouped and providing the opportunity for users within a group to communicate;

FIG. 18 is a schematic representation illustrating how business organizations having members can communicate through the reservation system for identifying members having a reservation at a Location for a period of time and notifying other members interested in making or who made a reservation at the same Location;

FIG. 19 is a schematic representation illustrating the administrative module receiving user information, including user Preferences, and creating one or more user's reference profiles and cooperating with the booking reservation system and the room administration system to assign an accommodation at the Location based on the user's preference profile; and

FIG. 20 is a schematic representation illustrating the administrative module receiving user Preferences including weighted and non-weighted Preferences and uses the Preferences to create user preference profiles and using the user preference profiles to group the users and cooperating with the room administration system of a reservation entity to assign an Accommodation to a user based on the group.

### DETAILED DESCRIPTION OF THE PREFERRED EMBODIMENT

The present invention solves the prior art problems discussed above and provides a distinct advance in the state of the art. The reservation system preferably is a computer-aided system that in a preferred embodiment operates to provide a collaborative system whereby Users using the reservation system and having reservations at a particular Location for a specific period of time can be grouped with other Users having the same or similar Preferences. The reservation system operates to place such grouped Users in Accommodations that are proximate to others within the group. Preferably, the reservation system continuously monitors changes in reservations made by Users and modifies Accommodations for the Users to improve the grouping or more aligns with a User's Preferences. The reservation system operates to provide a private personal telecommunication system whereby Users having a reservation for an Accommodation at a Location for a specific period of time can be placed in contact with other Users (“friends”) having reservations at that Location at the same or overlapping period of time and who share one or more of the same Preferences. In another preferred embodiment of the invention, the reservation system provides Users with the ability to receive business information from a specific Business Entity (such as, but not limited to those that are located near the Location) and/or which have been identified by the reservation system as providing services and/or products that may be of interest to the User. In another preferred embodiment of the invention, the reservation system allows a User to search and determine if other Users having the same of similar Preferences, such as Hobbies, and have reservations at a Location for a specific period of time or overlapping period of time. In another preferred embodiment of the invention, the reservation system communicates with business communication devices (organizational communications systems) of Business Entities or Business Organizations having individual member users for receiving and transmitting information concerning reservations made by other member users at a specific Location and period of time. It will be understood that subject invention is not limited to the preceding embodiments, benefits and advantages and that other embodiments, benefits and advantages of the invention will be apparent and described in the following description, the accompanying drawings and the appended claims.

In describing the preferred embodiments of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose. Further, as used herein the terms “User” or “Users” means those individuals, group of individuals, or entities making a reservation or has made a reservation(s) at a Location for a period of time and can include individuals, group of individuals, an organization, a business making one or more reservations, members or individuals associated with a Business Organization or association. As used herein the term “Location” refers to a facility such as a hotel, motel, lodge, cruise ship, resort, campground, time-share, or other similar facility that take reservations for Accommodations. As used herein, the terms “Accommodation” or “Accommodations” refer to a room, cabin, camp site, housing or other similar spaces. As used herein, the terms “Reservation Entity” or “Reservation Entities” refer to the entity that is recording and administrating a reservation for a Location and may include the management at a particular Location. As used herein a Booking Reservation System means a reservation system utilized at a specific Location for taking and administrating a reservation for a User at the Location or a national reservation system (such as used by a hotel chain, motel chain, cruise line, camping facilities chain, and the like), or a reservation system used to oversee reservations for multiple independent Reservation Entities (including, but not limited to, Internet travel sites or Apps such as TRAVELOCITY®, ORBITZ®, EXPEDIA®, PRICELINE®, and other such services). As used herein the term “Preference” refers to various Interests, Life-style and Hobbies of a User. As used herein, the terms “Interest” or “Interests” refer to activities, business activities, likes and dislikes of a User. For a non-limiting illustration, an Interest includes, but is not limited to, an interest in sports, history, sight-seeing, the arts (such as paintings, music, dance and the like), in articles (such as cars, technology, crafts and the like), in Business Activities, in conventions or conferences, and the like. The terms “Business Activity” or “Business Activities” refer to various business functions. For a non-limiting illustration, a Business Activity includes, but is not limited to, attending a business location, a business conference, a showing of business exhibits, a business convention, and the like. As used herein the term “Life-Style” refers to an individual's way of life. For a non-limiting example, whether an individual is married or single, has children or no children, has young children or teenage children or both, are young adults or middle age adults or older adults, is a quiet individual or one that enjoys social gatherings, is a smoker or non-smoker, sleeps later or stays up late, prefers low level (near ground floor) Accommodations or prefer higher level Accommodations, prefers an Accommodation having a certain view or facing a certain direction, prefers an Accommodation near a certain area (near a lounge, pool, exercise room, restaurant, vending area, near or away from an entrance, away from children or higher noise areas) and other such life-styles. As used herein the terms “Hobby” and “Hobbies” refer to a particular hobby (such as collecting objects), pastime, amusement, playing sports and avocations. For a non-limiting illustrative example, a Hobby can be a User who participates participating (playing) a sport (such as a tennis player, swimmer, golfer, etc.).

In a preferred embodiment, the reservation system creates and/or utilizes at least an entry point, such as an application (App), for use with tablets or cell phones (“smart phones”) and the like, or a one web-site, such as an Internet web-site, having a plurality of displays, such as web-pages. The entry point provides an interactive, menu and event driven structure that cooperates with a server or other like means, for using conventional prompt, dialog, and entry windows to guide a user to enter and/or obtain information. In another preferred embodiment of the invention, the reservation system also provides means whereby Businesses Entities can tap into the system to provide information, offers, and the like. Preferably, as will be described herein, a Reservation Entity or a Business Entity can use the reservation system to communicate with specific Users having or interested in making reservations or seeking information and who have indicated that they have a specific Preference or who have identified themselves as being interested in a particular type of business or that the User is associated with or are “members” in a Business Organization or Business Association. As used herein, the terms “Business Organization” and “Business Association” (collectively referred to as a “Business Organization”) means any business having members, memberships or associated individuals (including, but not limited to, vocational, hobby, fraternal, alumni groups that are formally organized or informally organized, as well as large professional/social network groups or subgroups having individuals that are associated by a common Interest or lifestyle. As used herein the terms “Business Entity” or “Business Entities” refer to any business that is interested in marketing and/or selling goods and/or services to Users, and includes Business Organizations. It will be apparent that by analyzing the information inputted by Users into the system, such as the Preferences and/or demographics of the Users, a Reservation Entity or a Business Entity (including a Business Organization) can tailor its marketing and advertising activities to specifically attract a specific type of User (customer).

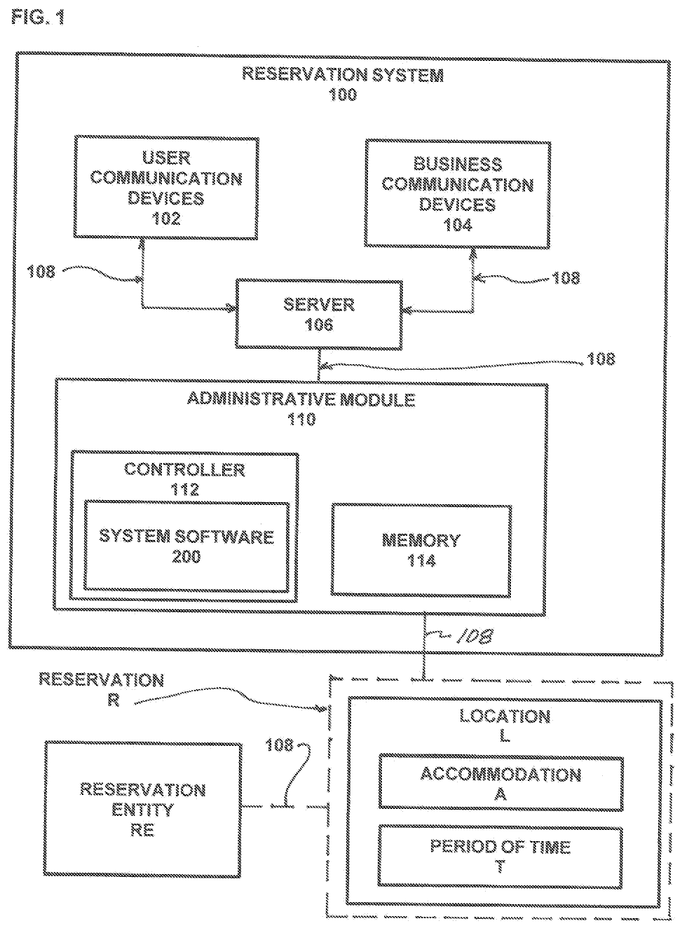

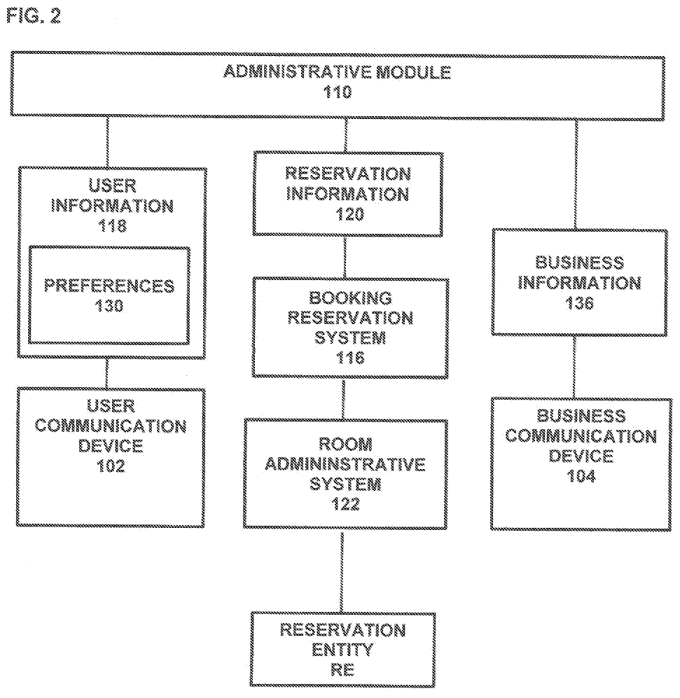

Referring to FIGS. 1 and 2, the subject reservation system 100 preferably includes a plurality of individual user communication devices 102, one or more business communication devices 104, at least one system server 106, an administrative module 110 for providing a link (junction) with one or more Booking Reservation Systems 116, and a communications network 108 for linking the components together. The communications network 108 may comprise one or more local or wide area networks, the Internet, other telecommunication systems, or a combination thereof. It should be understood that preferably the communications network 108 comprises the Internet but may also comprise other types of systems such as proprietary communications networks including text messaging systems, tweeter systems, telephone systems, PDA systems, and the like.

As shown, the administrative module 110 utilizes system software 200 (FIG. 1) that performs a portion of the method of the subject invention and is operated by or overseen by a system administrator (not shown). The administrative module 110 operates through the communications network 108 to assess and retrieve user information 118 from user communication devices 102 and business information 136 from business communication devices 104. Preferably, user communication devices 102 and business communication devices 104 can include computers, tablets, smart phones or any other suitable device that functions to provide communication with the administrative module 110 for transmitting information to the administrative module 110 and for receiving and displaying information received from the administrative module 110 for example by way of an APP (a computer program designed to run on a mobile device such as a phone/tablet or watch) or a website having various web-pages, as described herein below. As illustrated, the administrative module 110 includes a controller 112 and a memory 114 that communicate with the communication devices 102, 104. Preferably the administrative module 110 operates under the control of an operating system, such as the WINDOWS™ operating system developed by Microsoft Corporation or the Macintosh™ operating system developed by Apple Computer Corporation. It should be understood, however, that other operating systems could be utilized to implement the process of the reservation system 100 of the present invention.

Each individual user communication device 102 and business communication device 104 are preferably configured such that they communicate with the various other components of the reservation system 100 using the communications network 108 that can include the use of a DSL modem or a cable modem, a T-1 line, ISDN line, or the like. In a preferred embodiment, the system software 200 preferably utilizes conventional browser software suitable for communications over the communications network 108 and operates to provide communication between the administrative module 110, the various user communication devices 102 and business communication devices 104, as well as one or more Booking Reservation Systems 116.

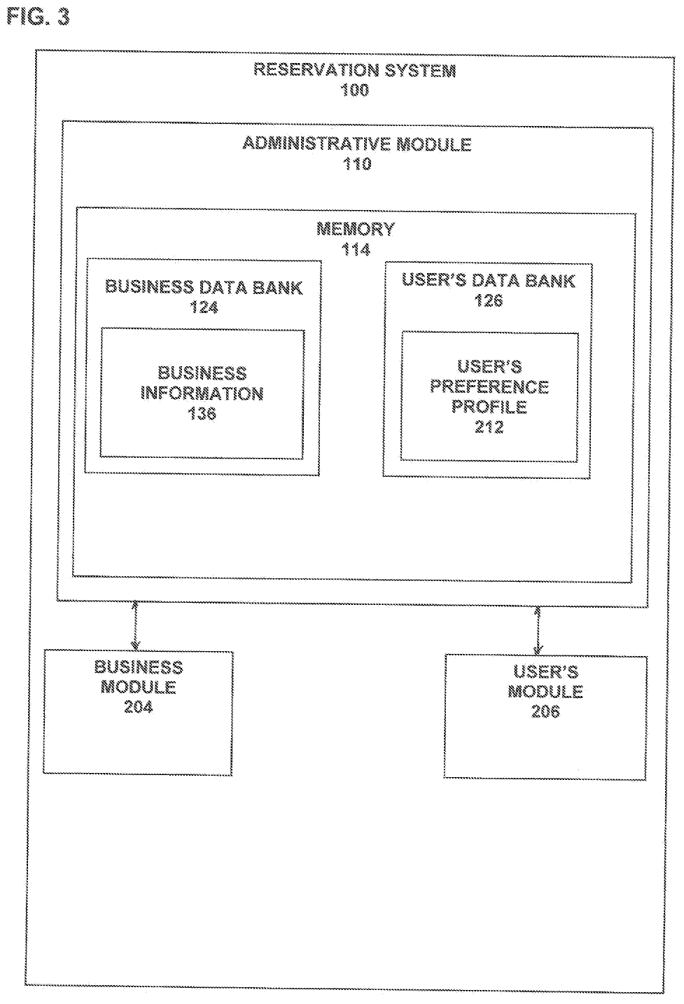

The reservation system 100 is not limited to a stand-alone reservation system as described below but preferably incorporate into or cooperates with Booking Reservation Systems 116 to make a reservation R for an Accommodation A at a Location L. As shown, the reservation system 100 is in communication with one or more Booking Reservation systems 116 through the administrative module 110 which operates as a junction point such that when a User U makes a Reservation R for an Accommodation A at a Location L, user information 118 and Reservation information 120 is transmitted to the administrative module 110. The administrative module 110 then operates to communicate with the Reservation Entity RE, such as by communicating with the room administration system 122 for the Reservation Entity RE at the Location L. As used herein the room administration system 122 is the particular system used by the Reservation Entity RE at the Location L to assign a particular or specific Accommodation to a User for the desired period of stay at the Location L. It should be understood that the room administration system 122 can be a separate system used by the Reservation Entity at the Location or can work in conjunction with a Booking Reservation System 116 or be incorporated into a Booking Reservation System 116. At the time a User makes a reservation at a Location for a period of time, the administration module 110 in communication with the Booking Reservation System 116 operates to identify Accommodations A at the Location L for the period of time T of the reservation R that are currently available and using User information 118 transmitted to the administrative module 110 identifies if the User is registered with the reservation system 100 and has created a user's preference profile 212 (FIG. 3) which is stored in a user's data bank 126. The administrative module 110 then operates in cooperation with the room administrative system 122 to assign an Accommodation A for the User that mostly matches the user's preference profile 212 such as described below. For a non-limiting illustrative example, a User making Reservation at a Location, depending on the user's preference profile, will be assigned an Accommodation that is proximate to other Users having reservations at the same Location for the same period of time and having similar Preferences. For another non-limiting illustrative example, a User listing young children on the user's preference profile will be assigned an Accommodation located near other Users having young children. Users having no children and having a Preference for a “quiet room” on the user's preference profile will be assigned an Accommodation away from Users having young children or near recreational facilities, such as pools, unless the user's preference profile list such a Preference. In another non-limiting illustrative example, Users, such as a User having Preference (such as an Interest in a particular sports team) will be assigned an Accommodations near other Users having an Interest in that sports team during a sports weekend and Users supporting a different team as listed in the user's preference profile will assigned an Accommodations located a distance away.

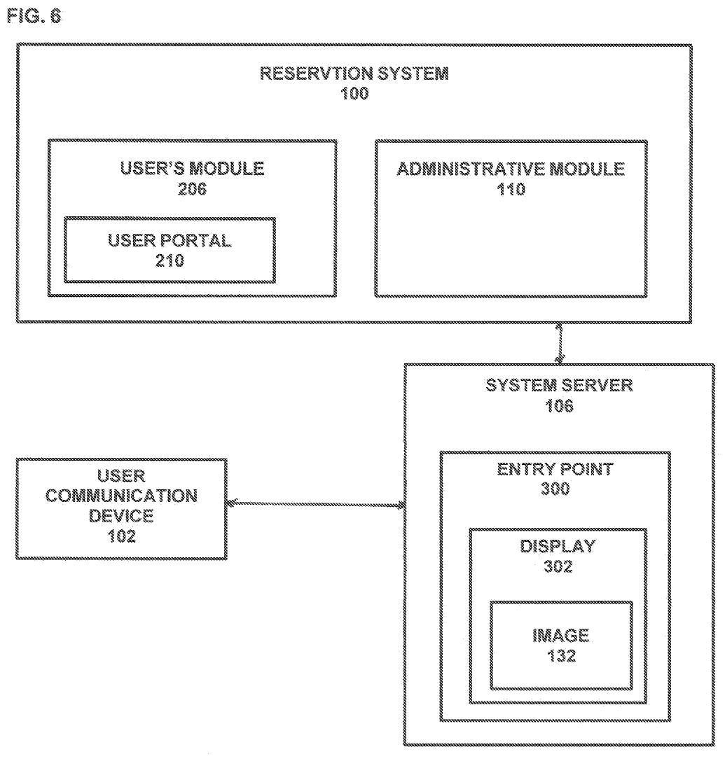

In a preferred embodiment of the registration system of the subject invention, a User U, using a user communication device 102 transmits user information 118, such as a Preference 130 in the form of a Hobby, to the administrative module 110 using the communication network 108. The administrative module 110 then operates to receive the user information 118 and stores the Preference 130 in the user's data bank 126 to create or update the user's preference profile 212. In making a Reservation through the reservation system 100, upon selecting a Location L and selecting dates of stay T at the Location, the administrative module 110 then operates to create a display page 302 on the user communication device 102 an image 132 that symbolizes one or more Hobbies (FIG. 6) listed in the user's preference profile 212 and the number of other Users having a reservation at that Location L during the same or overlapping period of time as the User's reservation having the same or similar Hobby listed in the users preference profile 212. In a preferred embodiment, the administrative module 110 further operates to display the number of other Users having a reservation at that Location prior to or after the period of time of the User's reservation, such a few days before of after, thereby allowing a User to consider changing the reservation time frame T allowing the User to have a reservation for a same period that more aligns with other Users having the same Hobby.

In operation, the administrative module 110 further operates to cooperates with the booking reservation system 116 to continuously monitor reservation changes in the Booking Reservation System 116 to identify changes in reservations at the Location (such as when a reservation is cancelled or changed) such that any changes in reservations at the Location will be immediately identified and cooperates with the room administrative system 122 at the Location L and compares the assigned Accommodations A for Users U and the user's preference profile 212 and if the change in the reservation based on the room administration system 122 allows a User's Accommodation A to be changed so it more closely satisfies (complies with) the user's preference profile 212, the administrative module 110 cooperating with the room administrative system 122 for that Location L operate to change the User's assigned Accommodation A. For a non-limiting illustrative example, a User having a high preference for an Accommodation near a pool, if an Accommodation is not available at the time the User makes a reservation, the User's Accommodation will be automatically reassigned to an Accommodation closer to the pool if such an Accommodation becomes available before the User checks-in with the Reservation Entity at the Location.

Referring to FIG. 3, a schematic representation illustrating the general methodology of the reservation system 100 of the present invention is shown. The administrative module 110 preferable communicates with a business module 204, and a user's module 206. In a preferred embodiment of the invention the administrative module 110 utilizes system software 200 (FIG. 1) that operates as a computer-readable medium having computer-readable instructions for automatically cooperating with the various components of the reservation system to operate the reservation system, such as generating the various web-pages or APP displays, described herein, that are displayed on the communication devices 102, 104 for use by Users, Business Entities and Reservation Entities in inputting and receiving information into and from the reservation system 100. Preferably, the system software 200 also operates as an interactive, menu and event driven system and cooperates with the system server 106 (FIG. 1) for generating conventional type of prompt, dialog, and entry fields and windows to guide a User (or a Reservation Entity or Business Entity including a Business Organization) to enter and receive information using the user or business communication devices thereby providing an interactive communications interface for facilitating communications and information exchange between individual Users, a Reservation Entity, Booking Reservation Systems, room administrative systems and Business Entities. As used herein, the term “software” refers to any form of programmed machine-readable language or instructions (e.g., object code) that, when loaded or otherwise installed, provides operating instructions to a machine capable of reading those instructions, such as a computer, and creating devices for performing certain operations of the reservation system. The system software 200 of the present invention can be stored or reside on, as well as be loaded or installed from, one or more floppy disks, CD ROM disks, hard disks or any other form of suitable non-volatile electronic storage media. The system software 200 can also be installed by downloading or other form of remote transmission, such as by using Local or Wide Area Network (LAN or WAN)-based, Internet-based, web-based or other remote downloading or transmission methods.

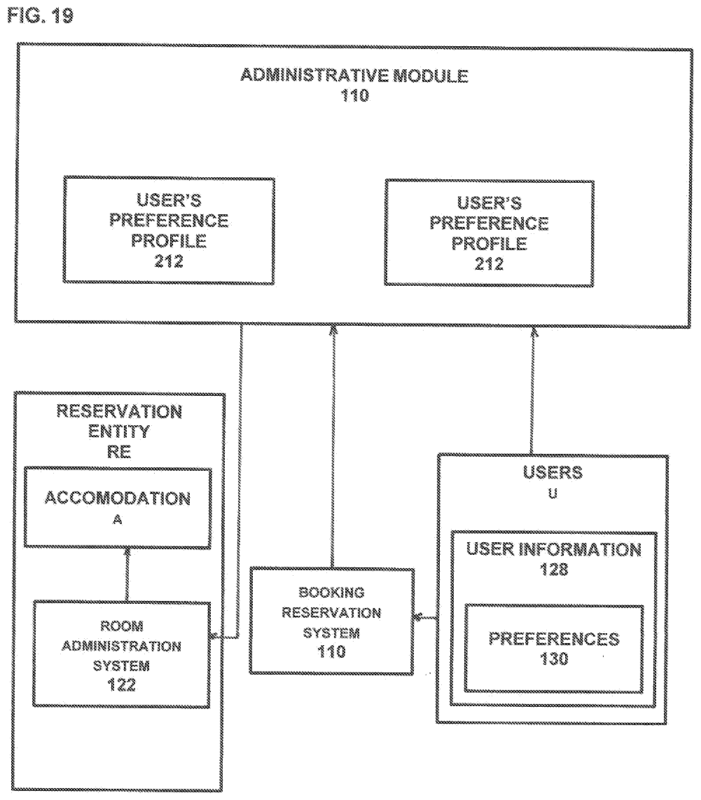

As shown in FIGS. 3-6, the administrative module 110 further provides the interface (junction or bridge) between the user's module 206 and the business module 204 for providing the ability for the Booking Reservation System 116 and room administrative system 122 used by a Reservation Entity RE to manage reservations R for individual Users U; provides the ability for Users U to make and modify registrations and to enter users information 128 (such as a user's Preferences 130) into the reservation system 100; to permit Users to communicate with other Users; to allow Users to search reservations at a Location for other Users having similar Preferences 130 and/or membership or associated with a Business Organization; and to allow Business Entities to communicate with the reservation system or other booking reservation systems 116, and Users who have a reservation or making a reservation using the reservation system 100. The administrative module 110, as illustrated in FIG. 19, also operates to group Users U into groupings 138 in accordance with their user's preference profiles 212 created by Users U inputted Preferences 130 and/or any association they may have with a Business Organization, as described below.

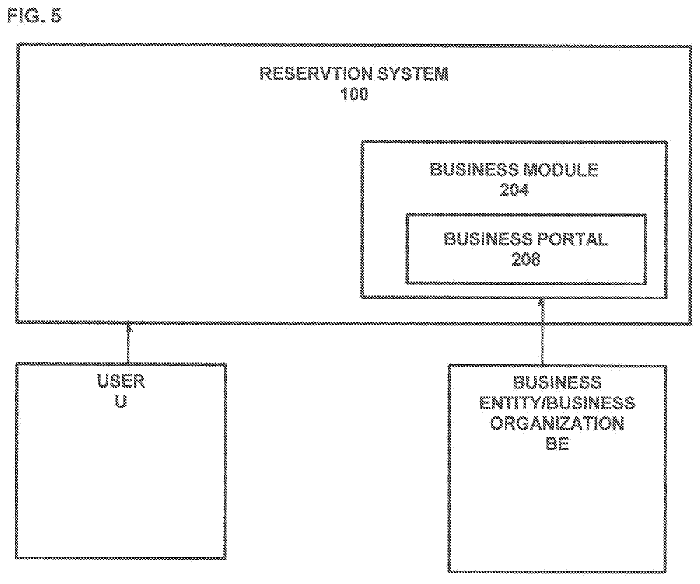

The business module 204, as shown in FIGS. 3 and 5, preferably comprises a general business portal or access 208 that operates to permit a Business Entity BE (including a reservation entity) to insert (input) and obtain (receive) information to and from the reservation system 100. The administrative module 110 operates to store and retrieve such information to and from a business data bank 124. The user's module 206, as illustrated in FIG. 6, comprises a general user portal or access 210 and is in communication with the business data bank 124 and a user's data bank 126 through the administrative module 110.

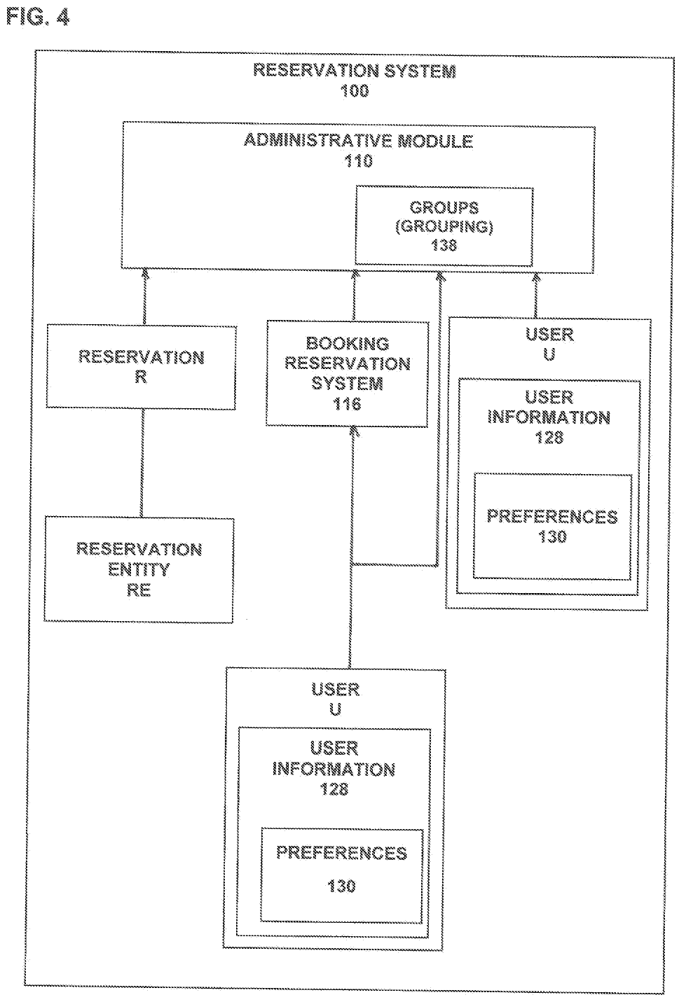

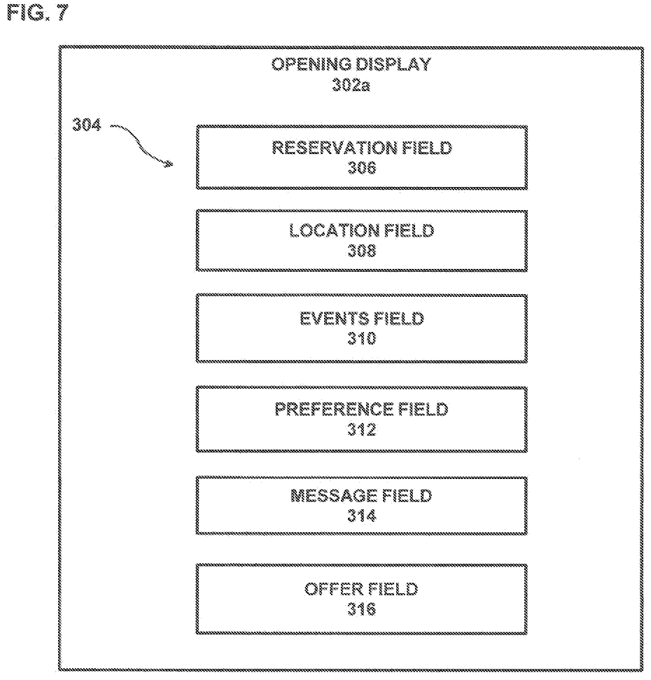

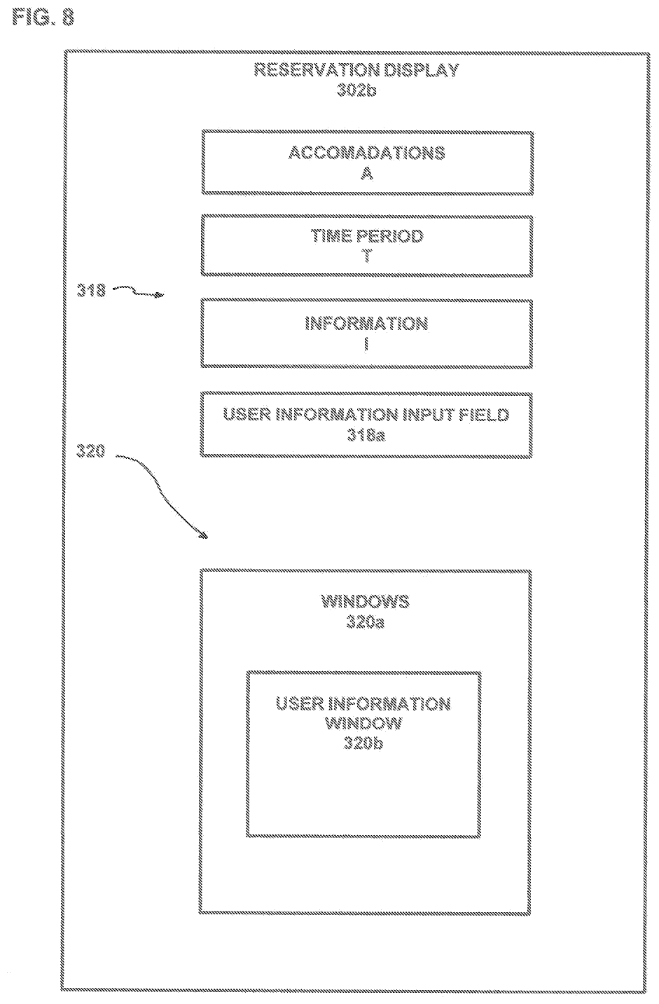

Referring to the figures, and specifically to FIGS. 4-7, the user's module 206 and the administrative module 110 are shown whereby a user U (FIG. 6) first accesses the user's module 206 through the general user portal or access 210 displayed on the user's communication device 102, such as through a system entry point 300, such as an App or created web site, having one or more display pages 302 (e.g. HTML pages and the like). The User U can then make a reservation R at a Location L for a specific period of time T using the reservation system 100 or provide user information 128, such as user Preferences 130. In a preferred embodiment, to initiate the reservation system 100, the individual User U, using an individual user communication device 102, obtains access the system through the user portal 210, via a communication network 108 to display the entry point 300 created and displayed on the user's communication device 102. The entry point 300, a shown in FIG. 7, provides the User U with various display fields 304 that provide options including, but not limited to, fields for making a reservation, reviewing Accommodation availability at a Location and/or obtaining information concerning the Location and Accommodations, obtain local business events and attractions, reviewing special offers, inputting Preferences of the User, as well as sending and receiving messages, and searching for other Users having similar or the same Preferences. It should be understood that the entry point 300 can also include other displays and options often found in other conventional reservation systems. As illustrated, the opening display 302a provides means, such as input/output fields and/or windows, whereby the User can make a registration R at a specific Location L for a specific period of time T, such as by selecting (“clicking”) the appropriate field 304. For an example, in the case of making a reservation, by “clicking” the reservation field 306 causes the administrative module 110 to automatically direct the user communication device 102 to display a reservation display 302b, as illustrated in FIG. 8 and described below, which permits selection and data entry into various windows 320a. As illustrated in FIG. 7, Users U are also given the option of selecting from a variety of fields 304 that causes the administrative module 110 to display on the user's communication device 102 a specific display page 302 that the User U may be interested in viewing. Such fields 304 include a “reservation” field 306, a “location” field 308, an “events” field 310, a “preference” field 312, a “message” field 314, and an “offer” field 316. It should be understood that by selecting any one of the listed fields 304 (or other fields described below), the administrative module 110 will operate to automatically show the appropriate display page 302 for viewing on the user's communication device 102. It should be understood that the display page 302 can also include any other fields found in other conventional reservation systems, such as, but not limited to a sign-in field, or subscription field.

As illustrated in FIGS. 1, 7 and 8, referring to the user reservation field 306 from the opening display 302a, the User U is permitted to make a reservation R at a Location L for a specific period of time T, such as by selecting (“clicking”) the reservation field 306 that directs the system software 200 to show a reservation display 302b. In this way once the user selects the reservation field 306 using the system server 106 operates to display the reservation display 302b on the user's communication device 102 (FIG. 2) thereby allowing the User U to make a reservation R “on-line” via the communications network 108. The reservation display 302b includes various reservation input fields 318 and reservation windows 320a that are used to allow a User to conventionally view and select a specific type of Accommodation A for a specific period of time T, or requesting information I, such as available Accommodations, price information, and the like. It should be understood that such input fields and windows are of the type that are conventionally used in reservation systems for making reservations on various Apps and Internet web-page systems. The reservation display 302b further comprises a user information input field 318a that when selected (“clicked”) opens one or more input windows 320a such as a user information window 320b which operates to permit a User U to enter and/or remove and/or edit personal user information and Preferences for creating a basic user's preference profile 212 (FIG. 3) which is stored in the user's data bank 126. Preferably, the user's preference profile 212 includes information about the individual User U, such as for example, but not limited to, the individual's age, marital status, children information, interests, club or membership in a business organization and Preferences. Such user information 118 after being entered is stored in the user's data bank 126 (FIG. 3) is used by the system for placing the User into a group 138, as will be described herein after.

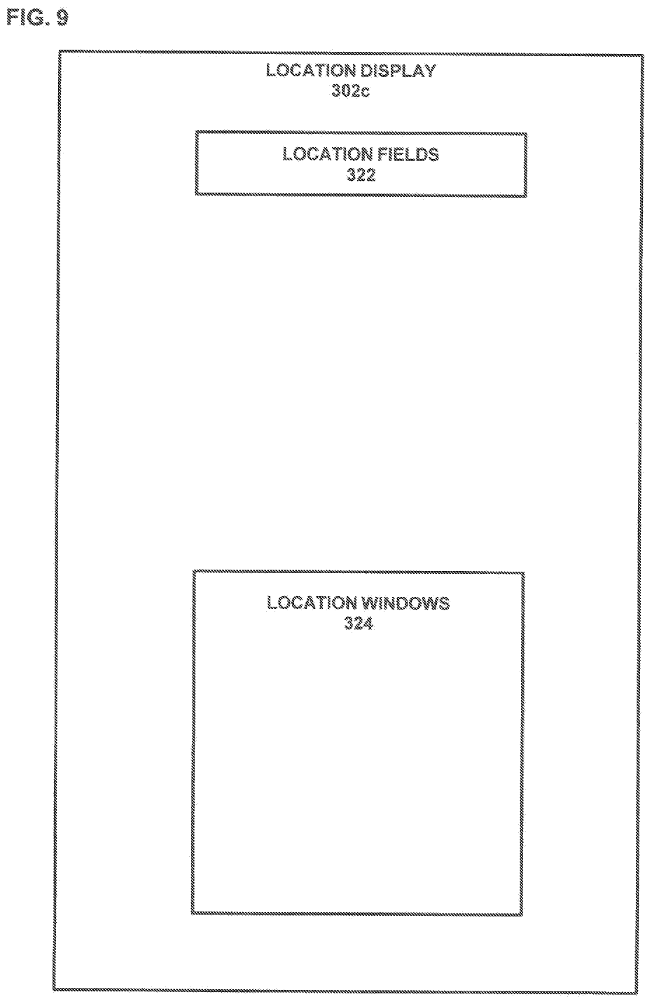

By selecting (“clicking”) the location field 308 on the opening display 302a, the system software 200 is directed to display a location display 302c on the user's communication device 102, as illustrated in FIG. 9. The location display 302c includes one or more various location fields 322 and location windows 324 typically found in conventional reservation displays that provide location information that describes the Location and the Accommodations at such Location. Such information can include, but is not limited to, a map of the Location, information describing features of the Location, local attractions, accommodation information, location policies (e.g. smoking and pet policies), pricing, and other pertinent information.

Referring again to the opening display 302a, the user U can select the events field 310 that causes the administrative module 110 to show an events display 302d on the user's communication device 102 (FIG. 2) which includes one or more events windows 328 for showing one or more drop-down events listing 326 of various community events, such as those near the Location L taking place during the user's period of time T at the Location. Preferably, included in the drop-down events listing 326 is certain relevant information, such as for example the name of the event, location (venue) of the event, date and time of the event, and other relevant information. The reservation system 100 further operates to allow the User U to request and obtain more specific information concerning one or more particular events by selecting (“clicking”) the particular event on the drop-down listing 328. If selected, the administrative module 110 then operates to show or direct the user U to a detailed event display, such as the business entity's web-page (not shown) that is offering the event that typically provides more detail about the selected event on the user's communication device 102. In a preferred embodiment, a User can search for particular events among the drop-down listing of events 326 stored in the business data bank 124, such as by type of event. For a non-limiting example, a User can search for a particular type of event, such as for example “sports” events that are scheduled during a specific period of time, venue, or other such parameters by selecting (“clicking”) on sports or a sport listed in the drop-down listing 326. In addition, Users can also search recommended events by selecting (“clicking”) the recommended events field 329 that when selected displays recommended events in an events window 328. It should be understood, that the recommended events may also be listed based on the particular user's preference profile 212. For another illustrative non-limiting example, if the User has identified sporting events to be a Preference, an events drop-down listing 326 will show recommended events that match the user's preference profile 212. Accordingly, an individual User is provided with a drop-down event listing that is a recommendation listing along the lines of the individual user's particular preference profile 212.

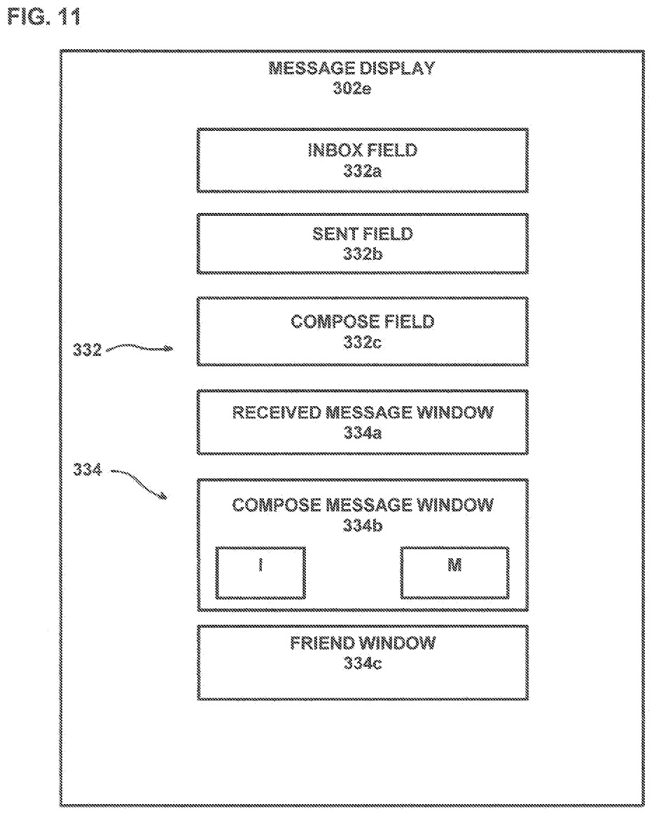

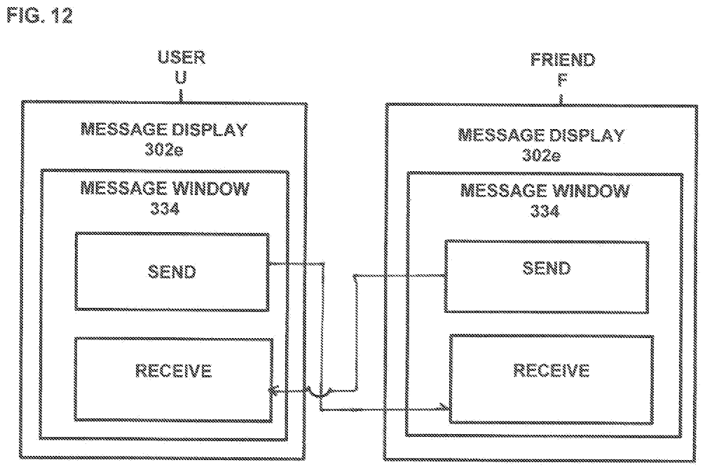

As shown in FIGS. 7, 11 and 12, when a User U selects (“clicks”) the message field 314 on the opening display 302a, the administrative module 110 is directed to show a message display 302e that provides one or more message fields 332 and windows 334 that together allow a User U to input information I or a message M and to direct the administrative module 110 to show the message M on the communication device 102 of a selected User F (hereinafter referred to as a “friend”) that has a reservation at the same Location L during the same or overlapping period of time T. For an example, a User U can send a message M to a friend F suggesting that the friend review information concerning a specific event, or request or invite the friend to participate in an activity. It should also be understood that in a preferred embodiment, events and offers that have been previously identified by the individual User as being of interest (based on the user's preference profile), will be automatically communicated to the individual User and displayed in an incoming message window 334. In this way individual Users can review all of the events being made by a Business Entity of interest (or in another preferred embodiment by the Reservation Entity) by simply reviewing their communication device 102. In a preferred embodiment, a User may also create a “private” event, such as for example by inviting one or more friends F to attend an event or participate in an outing, such as to play tennis or golf. It should be understood that in a preferred embodiment of the invention, a User after making a reservation at a Location for a specific period of time, can send out a message to other Users (“friends”) having a reservation at that Location at the same or overlapping period of time. Preferable, the reservation system 100 operates such that the identity of a User and a friend are not provided to each other unless the User and the friend directly provide such information to each other. In this way, the reservation system allows Users having reservations at a Location to communicate with other Users in an anonymous way. Such an anonymous communication operates to encourage Users to communicate with other Users that they have never met or know little about in a relatively safe way. It should be understood that the message display 302e operates to allow individual Users to review any messages sent by other Users (“friends”) (or a Business Entity or Reservation Entity) by selecting (“clicking”) on the inbox field 332a that operates to direct the administrative module 110 to show all messages received for the User in the received message window 334a. In another preferred embodiment, a User can review all messages the User sent to friends by selecting (“clicking”) on the sent field 332b which directs the administrative module 110 to show all messages sent by the User to friends in the friend window 334c. Accordingly, the system allows a review of messages sent to other Users (“friends”), or to compose messages and send the messages to other Users (“friends”) simply by selecting (“clicking”) the appropriate field, such as the message field 332, the inbox field 332a, the sent field 332b, or the compose field 332c, respectively.

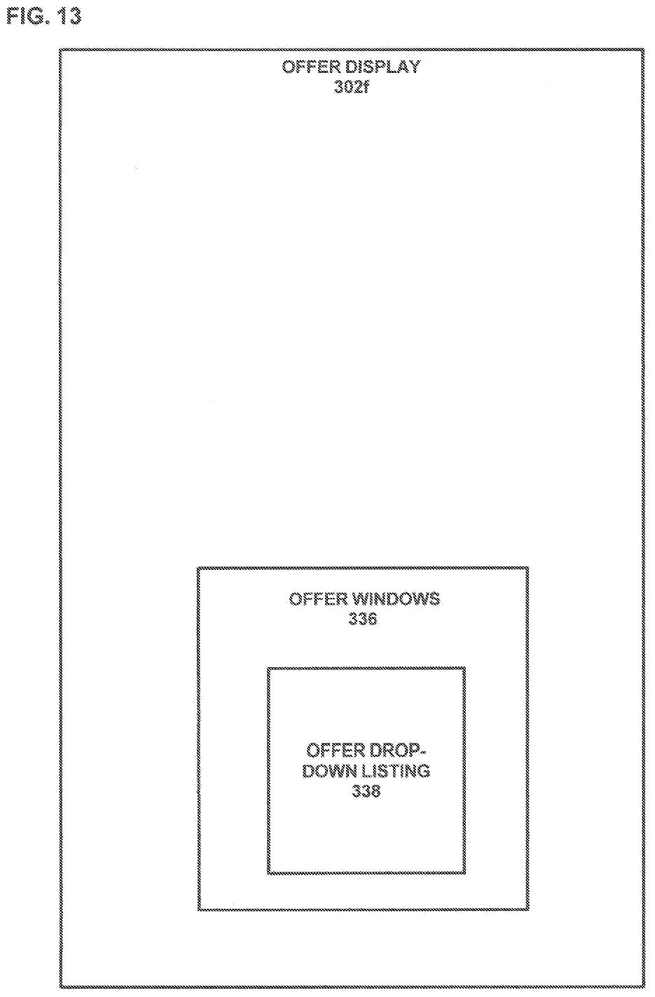

In a preferred embodiment of the invention, the User may select (“click”) the offer field 316 on the opening display 302a that operates to direct the administrative module 110 to show one or more offer windows 336 on an offer display 302f (FIG. 13) having at least one drop-down listing of offers 338 stored within the business data bank 124. In a preferred embodiment, a User can search for one or more particular offers among the offer drop-down listing(s) 338 stored in the business data bank 124, such as by type of offer (food, events, attractions, coupons, discounts, etc.). For a non-limiting example, a User can search for a particular type of offer, such as a food discount at a particular restaurant that are valid during a specific period of time, venue, or other such parameters. It should also be understood that a User can search for any number and type of offers including searching for various entertainment businesses or other types of businesses that are listed within the system. Further, it should be understood that such offers can be made by various Business Entities (including Business Organizations) and/or the Reservation Entity. Accordingly, a User can review the entire listing of offers or can select offers according to a specific Location, or alphanumerically, specific type of offer, or other such criteria which is then displayed on the user's communication device 102.

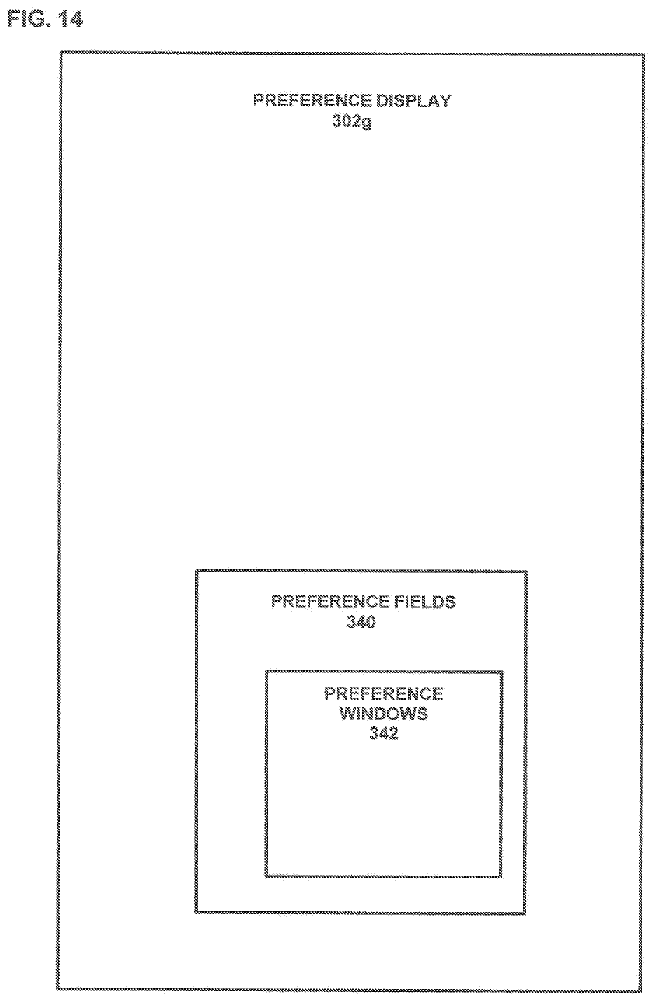

As shown in FIGS. 7 and 14, when a User U selects (“clicks”) the preference field 312 on the opening display 302a, the administrative module 110 is directed to show a preference display 302g that provides one or more preference fields 340 and windows 342 that together allow a User U to input preference information PI into the user's data bank 126. Such preference information is then sorted by the system software 200 to create a user preference profile 212. For a non-limiting illustration, the preference display 302g is provided with at least one preference window 342 that displays a drop-down listing of various questions concerning a User's Preferences. The questions can include requesting information concerning the user's marital status, number and ages of children, the user's age, occupation, pet information, nationality, education, interest in various cultural or sports activities (favorite type of sports, teams, etc.), interests in participating in a sporting event (i.e. finding others to pay tennis or golf with), membership and affiliation in various business associations and business organizations, and other such pertinent information.

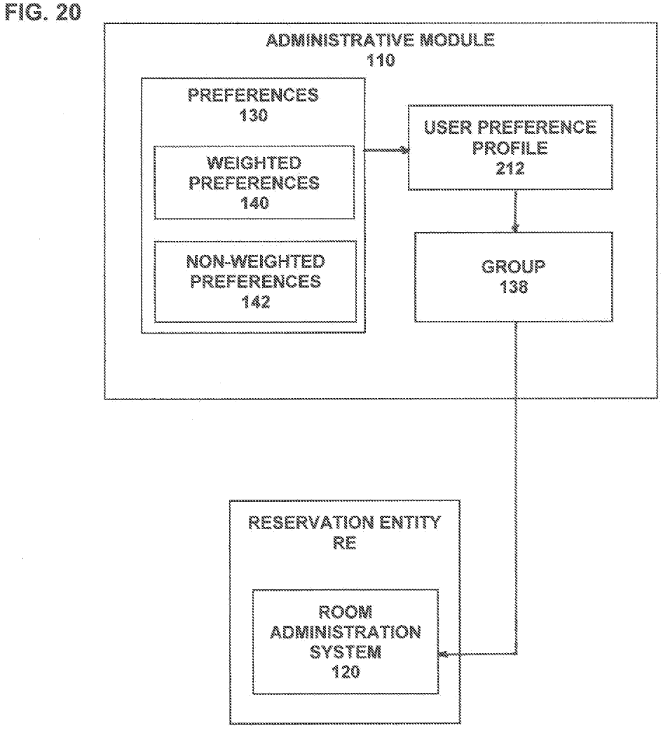

In a preferred embodiment of the invention, as illustrated in FIG. 20, the administrative module 110 further operates to create user preference profiles 212 that included weighted Preferences 140 and non-weighted Preferences 142. Users when entering user information 118, including Preferences 130, that are identified by the User as required in an Accommodation. For a non-limiting illustration, a user can rate each Preferences 130 in order of importance (weighing such Preferences). In this way the administrative module 110 of the reservation system 100 operates to place a User into one or more groups 138 based on the Preferences 130 listed in the user's preference profile 212 as well as the order (or ranking) of importance of each Preference 130. For another non-limiting illustration, a User can be placed into a group 138 comprising all Users interested in a specific sports team, or by age or family status, by membership in a Business Organization, or by age, or by any number of Preferences 130 wherein each User in the group 138 has placed such Preference 130 in the same or nearly the same order of importance. Such groups 138 can also be broken down into sub-groups, such as by weighing other Preferences 130 in accordance to the rating of importance made by the Users. Such groups 138 are then used by the administrative module 110 in cooperation with the room administration system 120 to assign and reserve Accommodations at the Location during the selected period of time that most closely satisfies or meets the User's Preferences 130 as well as their rankings of importance to the Users. For example, a User that indicates that non-smoking and easy access to entrances and exits are high priorities (heavily weighted Preferences), the administrative module operates to assign an Accommodation for the User in an area near an exit or entrance and in a non-smoking Accommodation in preference over other listed Preferences. Further, in the event no such Accommodation is available at the time the reservation is made, the administrative module communicates with and cooperates with the room administration system 120 to continually operate to monitor reservations and accommodations for that period of time and in the event a reservation is cancelled by others, the administrative module cooperating with the room administration system 120 automatically modifies the assigned Accommodation to accommodate the User's highly ranked Preference. Thus, the administrative module operates to continuously and in real time cooperating with the room administration system 120 to modify assigned Accommodations to optimize and better satisfy all of the User's Preferences and most particular the user's highest ranked Preferences.

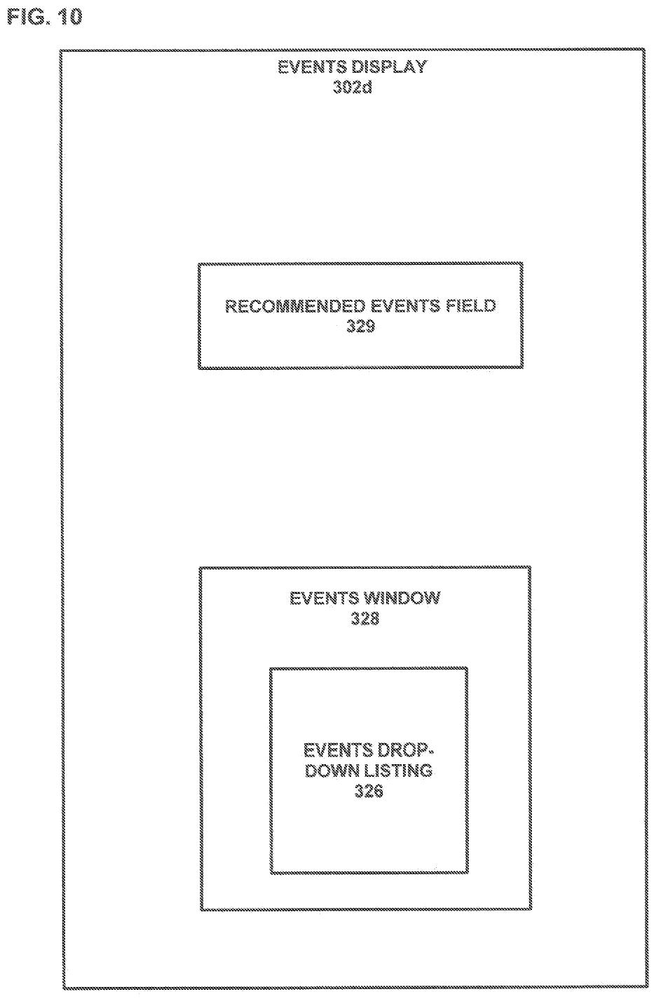

It should be understood that FIGS. 7-11 and 13-14 are exemplary illustrations of representative displays that would be generated by the administrative module and displayed on the user's communication device. It should be understood, however, that the subject invention is not limited to the specific format of the displays and other displays having alternative formats can be used within the scope of the subject invention. In another preferred embodiment, the administrative module of the system is also provided with a security feature that ensures only the proper User having a reservation is able to access the User's reservation and inputted information for inputting, modifying, and deleting reservations and personal user information, such as a user's preferences profile. Preferably, the security feature is the use of a conventional password feature, such as typically used to enter restricted areas of an Internet website, however other security features, such as conventional user ID system or an Email access mechanism, could be used. It should be understood that the security feature will be utilized by the system anytime a User attempts to gain access to various information stored within the system or to modify, edit, or add such information into the system. It should also be understood that a User can modify, edit, or delete certain of user's information, such as passwords, Email, and profile information by selecting the appropriate field.

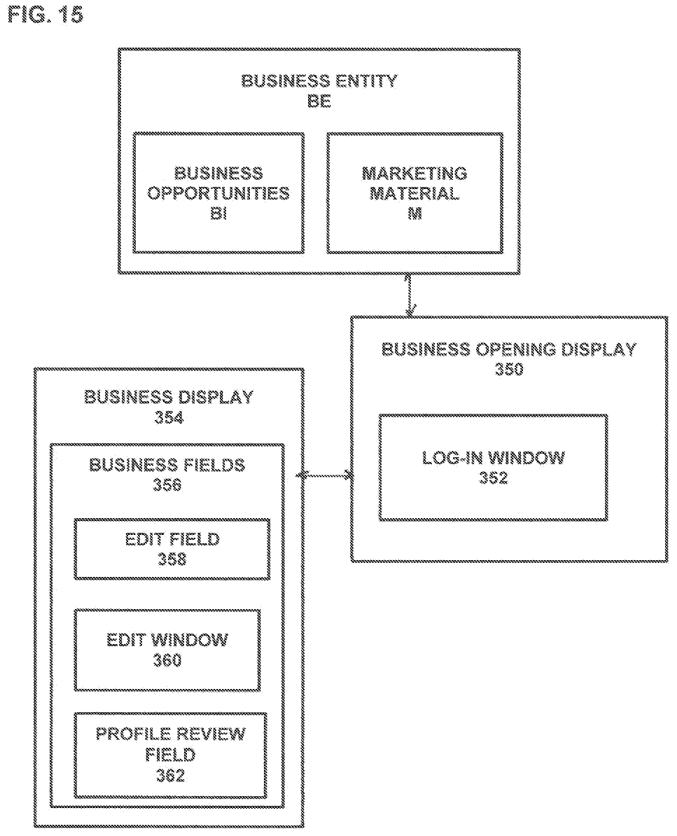

Referring to the FIGS. 3 and 15, the business module 204 and the administrative module 202 are shown whereby a Business Entity BE first opens or enters the business opening display 350 to initiate the system 100. The Business Entity BE (or a Reservation Entity) using a business communication device 104 obtains access to the system, through the entry point 300, via a communication network 108 and the business portal 208 to provide “login information” such as by use of a log-in window 352. Once the Business Entity “logs in,” the administrative module 110 operates to allow the Business Entity BE access to the stored information 136 relating to that particular Business Entity BE and to review/add/subtract or modify the business entity's information 136 stored within the business data bank 124. In a preferred embodiment the administrative module 110 operates to create and show a business display 354 which preferably contains various business fields 356, such as an edit field 358 that when selected (“clicked”) directs the administrative module 110 to display an edit window 360 for inputting, reviewing and editing events and/or offers; and a profile review field 362 that when selected (“clicked”) directs the administrative module 110 to display the user's preference profile 212 of Users at a Location over a period of time. Thus, the Business Entity (or a Reservation Entity) can plan and schedule business opportunities BI (such as events and offers) quickly and easily and which can be directed towards users having particular Preferences. In another preferred embodiment, once a new business opportunity has been entered as business information 136 into the reservation system 100 by a Business Entity BE, the administrative module 110 operates to communicate the new business information 136 to Users that have been identified by their user's preferences profile 212 as having an interest in receiving information concerning the particular type of business information 136. For example, business information 136 can be communicated via Email or directly through the reservation system 100. In another preferred embodiment, Users can request to receive periodic communications that inform them of new business information 136 that have been entered into the reservation system 100. Thus, it should now be apparent that user's preference profiles 212 can be communicated to various Business Entities BE (or to a Reservation Entity) thereby allowing a Business Entity (or Reservation Entity) to target specific Users U (customers). In this way, a Business Entity BE (or Reservation Entity) utilizing the reservation system 100 of the subject application can now easily create effective marketing and promotional programs to promote their business to Users (consumers). Business Entities BE (or a Reservation Entity) can also create, edit, and post information about their business and/or events and/or offers which are stored in the business data bank 124 for review by Users U (customers), such as by the User selecting (“clicking”) the appropriate field 304 (i.e. events field 310 or offer field 316 on the opening display 302a) or its App or web site can be linked to the reservation system 100. The reservation system 100 further allows Business Entities BE (or a Reservation Entity) to create and publish marketing material, such as special offers, targeted to Users U for acquiring new customers. Further, user information, such as Email addresses, phone numbers, and addresses, can be used by Business Entities (or a Reservation Entity) for off-line and on-line marketing means. It should now be apparent that the reservation system together with user Preference information contained in the user's preference profile provides a means whereby Business Entities (and/or a Reservation Entity) can significantly increase its exposure to potential new customers and can direct its marketing activity to those Users that have acknowledged or shown an interest in a business (or venue), or in services or products that are offered by a Business Entity.

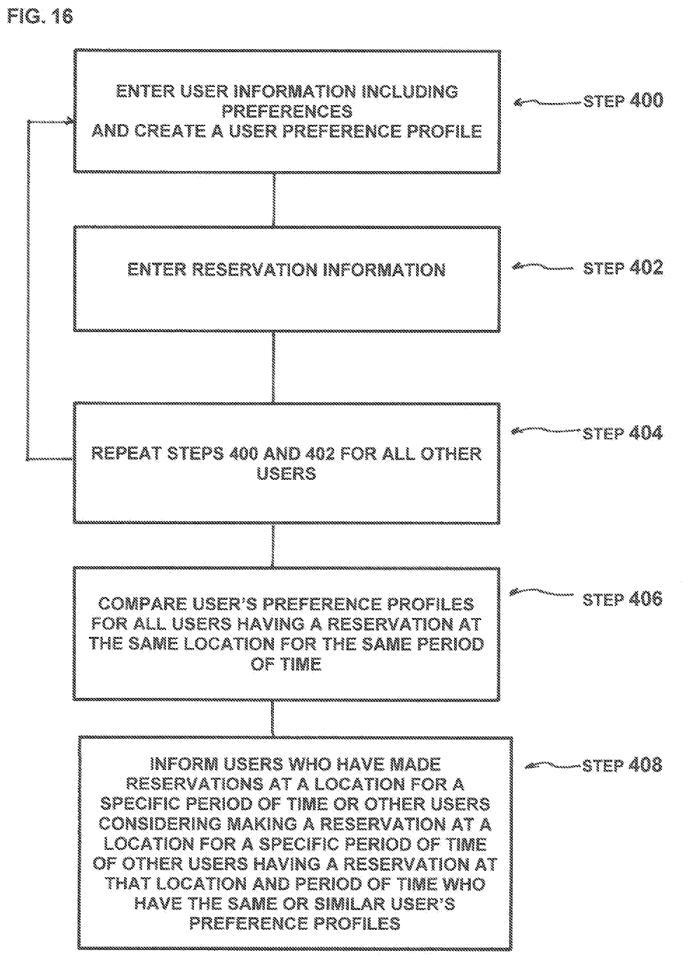

Referring to FIG. 16, a schematic representation illustrating the general methodology and interactive method for grouping Users based on the user's preference profile is shown. As shown, information for a User having a reservation (or planning a reservation) inputs user information 118, such as Preferences 130, into the system 100 (such as through the reservation display 302b) which is stored in the user's data bank 126 as the user's preference profile 212 (step 400). The User can also input other user information 118, such as reservation information (or if a reservation is being made, it will automatically be entered and stored in the user's data bank 126), such as the desired Location L and period of time T at the Location (step 402). The process is repeated for other Users (step 404). As other Users enter such user information 118, the administrative module 110 operates to compare the Preferences 130 contained in the user's preference profile 212 with the Preferences 130 contained in all of the other user's preference profiles 212 for Users having reservations (or planning a reservation) at the same Location L for the same or overlapping period of time T (step 406). In a preferred embodiment, each User is provided with information informing the User of other Users having reservations at same Location and the same or overlapping period of time (step 408). It should be understood that various was placing Users into groups 138 can be performed, such as by number of similar Preferences comparisons; comparing Preferences by user priorities (Preference ranking); and other similar ways to group Users. For an exemplary non-limiting illustration, all Users desiring a quiet Accommodation may all be placed by the reservation entity RE in Accommodations near each other. For another exemplary non-limiting illustration, all Users having children may be placed by the Reservation Entity in Accommodations near each other. For another exemplary non-limiting illustration, all Users supporting or are fans of a particular sports team may be placed by the Reservation Entity in Accommodations near each other. In a preferred embodiment, a user prior to making a reservation at a Location for a specific period of time, can examine or receive information from the Reservation Entity (or Business Entities) information concerning other Users having similar user preferences profiles that have reservations at the Location for the same or overlapping period of time which can be used by the User in determining if he/she wishes to make a reservation at that Location for that period of time.

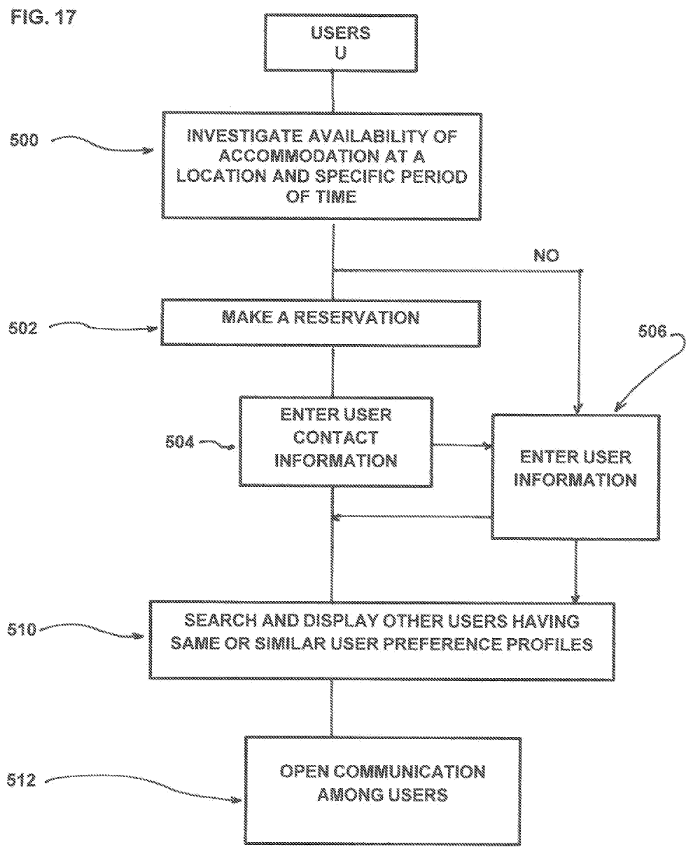

Referring to FIG. 17, a schematic representation illustrating the general methodology and interactive method whereby Users having a reservation at a Location for a specific period of time can arrange to meet other Users (friends) that share the same or similar Preferences who have a reservation at the same Location (or a location in the near vicinity) for the same or overlapping period of time. As shown, in this preferred embodiment, a User investigates a Location and Accommodation availability for making a reservation for a specific period of time (step 500). If there is open Accommodation, the User then makes a reservation at the Location for a specific period of time (step 502). If the User is interested in communicating with other Users who have a reservation at the same Location and the same or overlapping period of time, the User enters the User's contact information, such a telephone number or Email address or can communicate through the reservation system as previously described (step 504). If the User has not already entered the user's Preferences into the system, the system operates to permit the User to enter such user information into the system (step 506). If the User does not wish to enter such user information, the administrative module operates to direct the User to the opening display to allow the User to investigate events and offers (step 508). In a preferred embodiment of the invention, the administrative module further operates to review all reservations made at the Location during a specific period of time, or overlapping period of time, and displays information concerning other Users having a reservation who share the same Preferences as the User (step 510). Accordingly, the system operates to identify other Users (“friends”) that have reservations at the same Location and period of time or overlapping period of time and who share the same or similar Preferences and operates to request if the User is interested in communicating with “friends” and if so, further operates to provide communication between the User and the friend(s) (step 512).

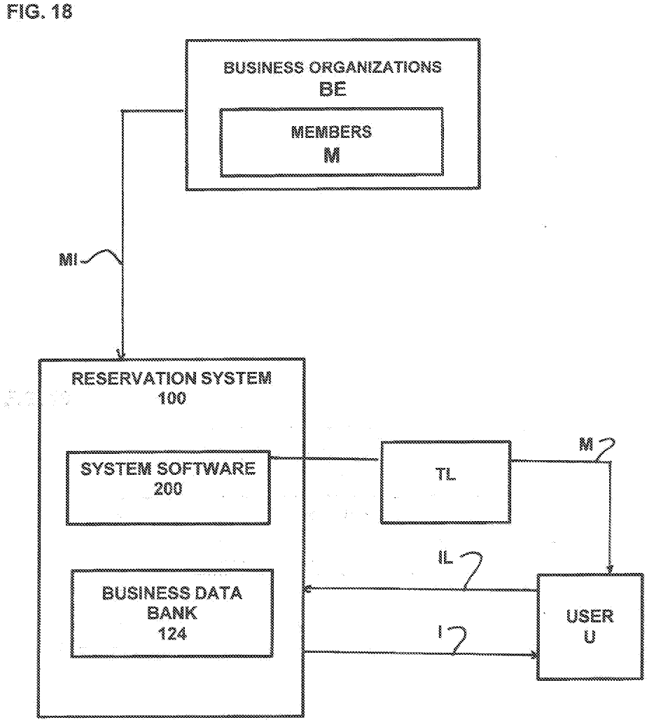

Referring to FIG. 18, in another preferred embodiment, the Business Entity is a Business Organizations BE having associated individuals, referred to generally as members M. Preferably, the Business Organization enters business information 136 (such as membership information or a listing of members—individuals associated with that Business Organization), for instance by batch loading, into the business data bank 124 using a business communication device 104 (FIG. 1). A User U, while investigating the availability of an Accommodation A at a Location L for a specific period of time T, inputs into the system 100 the user's affiliation (membership) in the Business Organization, such as through the Preference display 302g (FIG. 14), and the administrative module operates to review the Preference 130 (FIG. 4) with the business information, membership listing stored in the business data bank 124 and provides that User U (who is also a member) with information I concerning other Uses M (who are listed one the listing of members) who have a reservation at that Location for the same or overlapping period of time. In another preferred embodiment, Users U who already have inputted Preferences 130 which is stored in the user's data bank 126, the administrative module operates to continuously monitor reservations at a Location L and sends information I to Users concerning other Users (members) who have made a reservation at a Location for a specific period of time. For a non-limiting illustration, the administrative module monitors reservations and when a threshold level TL of Users having a membership in or an association with a particular Business Organization have made reservations at a Location for a period of time, the system sends out user messages UM to Users who have a user preference profile in the system and who have been identified as having an association with or a membership in that Business Organization. In another preferred embodiment a Reservation Entity can monitor the user preference profile of Users who have made a reservation at a Location or interested in making a reservation and notifying the User if other Users, such as those listed on a membership listing in a Business Organization and who have similar Preferences as the User, have made a reservation at the Location for the same or overlapping period of time. In this way, Locations in areas where events (such as conventions, trade shows and the like) will be taking place can target and attract Users (customers) who may be attending such events at their Location or in the area. Further, Reservation Entities and Business Entities can target specific Users with offers thereby increasing the likelihood of attracting customers (Users). It should now be apparent that the reservation system of the subject invention allows business information, such as a listing of members of a Business Organization to be entered (such as by batch downloading) into the business data bank and operates to identify a User who is listed on the listing of members and who has made a reservation at a Location for a specific period of time and to notify other Users who are listed on the listing of members that one or more other Users who are listed on the listing of members have made a reservation at such a Location and period of time. In this way, Users seeking to make a reservation can search and find a Location that have reservations for Users who share the same Preferences. Further, it should now be apparent that reservation entities and Business Entities can increase marketing opportunities by tailoring events and offers targeted to such Users. Further, Business Organizations can offer marketing and membership benefits, such as negotiating special prices, events and offers with Business Entities and reservation entities to users identified in its downloaded membership listing. It should also now be understood that Users (confirmed users) having an association with a Business Organization and who have made reservations at a Location for a specific period of time can be “tagged” such that other Users who also have an association with that Business Organization and who are considering making a reservation for the same period of time (or an overlapping period of time) will be notified or alerted to the reservations made by the conformed Users and the Location of such reservations.

Accordingly, it should now be understood that the reservation system of the subject invention for use by one or more Users to make a reservation for an Accommodation at a Location for a specific period of time, comprises an administrative module, a plurality of user communication devices for use by Users in making reservations, and a communications network connecting each user communication device to the administrative module, wherein the administrative module operates to receive information from each User and uses the information to place each User into a group. The system further operates such that the administrative module then operates to assign an Accommodation to each User based on the group. In a preferred embodiment of the invention, the information includes Preferences for each User, such that each group consists of Users having the same or similar Preferences. In another preferred embodiment of the invention the administrative module operates to prioritize (weighs or ranks) the Preferences. Further, the reservation system comprises business communication devices that operate to receive business information from a Business Entity and transmits the business information to the computer system for storage in a business data bank, and wherein the administrative module operates to transmit the business information to one or more Users. In another preferred embodiment, the business information comprises a listing of members of the Business Entity, and the administrative module operates to identify a User making a reservation as being listed on the listing of members and notifies the User of other Users listed on the listing of members who have a reservation at the same Location and period of time. Further, business information can comprise events and/or offer information.

It should also now be apparent that the reservation system described herein can also operate to provide marking and promotional opportunities to Businesses Entities selling products (such as for an example retail businesses) or providing various types of services (such as for an example restaurants and entertainment) and allows a Business Entity to target Users having a reservation at a Location for a specific period of time based on the User's inputted Preferences.

The reservation system of the subject invention operates to allow Business Organizations to input membership lists and/or information into the system and uses such information to inform Users investigating a Location to make a reservation or when making a reservation and who have indicated they are members of such Business Organization, that other members have a reservation at that Location and period of time. In this way, locations can market to such members and can provide offers and events that are targeted to such members.

It should also now be apparent that the reservation system described herein allows Users to be introduced to other Users having reservations at the same Location and period of time (“friends”) and allow the Users to invite friends to private parties, events, and outings.

What is claimed is:

1. A reservation system for use by one or more users to make a reservation for an accommodation at a location for a specific period of time, the reservation system comprising:
an administrative module;
a plurality of user communication devices for use by users in making reservations;
a communications network connecting each user communication device to said administrative module;
wherein said administrative module operates to receive user information from each user through said user communication device uses said user information to create a user preference profile for each user and uses said user preference profile to place each user into a group and wherein said administrative module communicates with a room administrative system to assign an accommodation at the location for the specific period of time based on the group.

2. The reservation system of claim 1 wherein said user information includes user hobbies, such that each group consists of users having the same or similar hobbies.

3. The reservation system of claim 2 wherein said user information includes weighted preferences.

4. The reservation system of claim 3 wherein the administrative module operates to communicate with the room administrative system to continuously monitor reservations at the location and the specific period of time and cooperates with the room administrative system to modify accommodations to more closely comply with each said user's preference profile.

5. The reservation system of claim 1 further comprising business communication devices that operate to receive business information from a business entity and transmit said business information to said administrative module for storage in a business data bank, and wherein said administrative module further operates to transmit said business information to one or more users based on the user's preference profile.

6. The reservation system of claim 1 wherein said administrative module operates to receive business information comprising a listing of members of a business organization, and wherein said administrative module further operates to identify a user making a reservation at the location for the specific period of time as being listed on said listing of members and notifies the user of other users listed on said listing of members who have made a reservation at the location for the same period of time.

7. The reservation system of claim 5 wherein said business information comprises events and/or offer information.

8. The reservation system of claim 1 wherein said administrative module operates such that users each having a reservation at the same location and for the same or overlapping period of time can communicate with each other using said user communication devices.

9. The reservation system of claim 1 further comprising one or more displays having display fields and windows for entering and receiving user information.

10. A reservation system for use by one or more users to make a reservation for an accommodation at a location for a specific period of time, the reservation system comprising:
an administrative module;
a plurality of user communication devices for use by users in inputting and receiving user information, wherein said user information comprises user preferences;
one or more business communication devices for use by business entities to input and receive business information;
a communications network connecting said user communication devices and said business input/output devices to said administrative module;
wherein said administrative module operates to receive user information from each user and uses said user information to create a user's preference profile for each user and to place each user into a group based on said user's preference profile;
wherein said administrative module communicates with a room administrative system that operates to assign an accommodation at the location for the specific period of time;
wherein said administrative module and the room administrative system cooperate to assign an accommodation for each user at the location for the specific period of time based on said group; and
wherein said administrative module further operates to transmit business information to users based on said group.

11. The reservation system of claim 10 wherein said group is based on weighted preferences in said user's preference profiles.

12. The reservation system of claim 11 wherein the administrative module further operates to communicate with the room administrative system to continuously monitor reservations at the location and specific period of time and modify accommodations to more closely comply with each said user's preference profile.

13. The reservation system of claim 10 wherein said administrative module operates to receive business information comprising a listing of members of a business organization, and wherein said administrative module further operates to communicate with a plurality of room reservation systems to identify a user making a reservation as being listed on said listing of members and notifies the user of other users listed on said listing of members who have made a reservation at a location for a period of time.

14. The reservation system of claim 10 wherein said business information comprises events and/or offer information.

15. A reservation system for use by one or more users to make a reservation for an accommodation at a location for a specific period of time, the reservation system comprising:
an administrative module;
a plurality of user communication devices for use by users in inputting and receiving user information, wherein said user information comprises user preferences;
one or more business communication devices for use by business entities to input and receive business information;
a communications network connecting said user communication devices and said business input/output devices to said administrative module;
wherein said administrative module operates to receive user information from each user and wherein said user information includes preferences, wherein said preferences includes weighted preferences;
wherein said administrative module then operates to create a user's preference profile for each user based on said preferences and uses said user's preference profile for each user to place each user into a group;
wherein said administrative module communicates with a room administrative system that operates to assign an accommodation at the location for the specific period of time based on said group;
wherein said administrative module further operates to transmit business information to users based on said group; and
wherein the administrative module further operates to communicate with the room administrative system to continuously monitor reservations at the location and specific period of time and modify accommodations to more closely comply with each said user's preference profile.
